(19) United States
(12) Patent Application Publication
(10) Pub. No.: US 2025/0354539 A1
(43) Pub. Date: Nov. 20, 2025

(54) WIND TURBINE AND METHOD FOR OPERATING A WIND TURBINE

(71) Applicant: Nordex Energy SE & Co. KG, Hamburg (DE)

(72) Inventors: Konrad Sachse, Hamburg (DE); Jochen Kremer, Hamburg (DE); Stefan Kruth, Rerik (DE); Oliver Heick, Henstedt-Ulzburg (DE); Christof Rautmann, Norderstedt (DE); Jörgen Korpelainen, Sveg (SE)

(21) Appl. No.: 19/191,924

(22) Filed: Apr. 28, 2025

(30) Foreign Application Priority Data
May 15, 2024 (EP) 24175993.5

(51) Int. Cl. F03D 80/40; H05F 3/02

(52) U.S. Cl. CPC F03D 80/401; H05F 3/02

(57) ABSTRACT

A wind turbine includes a rotor blade, an electrical system embedded in the rotor blade and at least one switchable connection between the electrical system and ground. The at least one switchable connection is controllably switchable between an open state and a closed state so that, when the at least one switchable connection is in the closed state, the electrical system is grounded, and, when the at least one switchable connection is in the open state, the electrical system is not grounded.

### CROSS-REFERENCE TO RELATED APPLICATIONS

This application claims priority of European patent application no. 24175993.5, filed May 15, 2024, the entire content of which is incorporated herein by reference.

### TECHNICAL FIELD

The present disclosure relates to a wind turbine and a method for operating a wind turbine.

### BACKGROUND

Wind turbines are widely known and are used to convert wind energy into electrical energy. Wind turbines are operated under various ambient conditions, which makes the components of the wind turbine subjected to harsh atmospheric conditions including, but not limited to, extreme cold weather, lightning, and storms. A rotor blade of the wind turbine may also become electrically charged with respect to ground due to air friction or due to precipitation, which may lead to accumulation of electrostatic charge on the surface of the rotor blade. The presence of electrostatic charge may interfere with the working of the electrical components present in the wind turbine. On certain occasion, due to the presence of static charge, current spikes may be observed with the help of a current measuring device. The electrical system in the wind turbine may become prone to malfunctions and errors due to accumulated static charge, eventually causing the wind turbine to get automatically triggered for a shutdown process and thereby affecting the overall energy demand. If this electrostatic charge cannot be dissipated, the electrostatic charge can damage the component or the whole wind turbine.

### SUMMARY

One object to be achieved is to provide a wind turbine having a system for dissipating and/or determining electrostatic charge accumulation in an electrical system, particularly in a rotor blade of the wind turbine and a method to discharge the accumulated electrostatic charge. Further objects to be achieved are to provide a method for operating such a wind turbine as well as a computer program, a computer-readable data carrier and a control device for executing the method.

First, a wind turbine is specified.

According to an embodiment, the wind turbine includes a rotor blade, an electrical system embedded in the rotor blade and at least one switchable connection between the electrical system and ground. The at least one switchable connection is controllably switchable between an open state and a closed state so that, when the at least one switchable connection is in the closed state, the electrical system is grounded, and, when the at least one switchable connection is in the open state, the electrical system is not grounded.

The present disclosure is, inter alia, based on the recognition that rotor blades which have an electrical system can become electrically charged with respect to ground, for example due to air friction and/or precipitation static, for instance in humid air conditions. To eliminate the accumulated electrostatic charge, the electrical system needs to be grounded, but at the same time the electrical system remains inoperable until it is disconnected from the ground.

To this end, the present disclosure suggests providing a switchable connection which can be controllably switched in order to ground the electrical system and to dissipate the electrostatic charge to the ground.

The wind turbine includes, for instance, a rotor with one or more, for example three, rotor blades. The rotor may be coupled to a generator, for example, via a gearbox, so that rotation of the rotor can be transformed into electrical energy.

An electrical system is assigned to the rotor blade, particularly embedded in the rotor blade. The electrical system includes, for example, one or more conductors through which, during operation of the electrical system, electric current is running. The electrical system may include a lightning protection system which, when a lightning strikes the rotor blade, automatically establishes an electrical connection to ground and safely conducts the lightning current to the ground without damaging the wind turbine. This electrical connection is herein also called “overvoltage connection”. The overvoltage connection is a non-switchable connection because it cannot be switched in a controlled manner. Instead, the overvoltage connection is established automatically, for example due to electrical breakdown when a breakdown voltage is reached.

The switchable connection can be switched controllably. It may be switchable intentionally. The switchable connection may include a mechanical switch which can be controlled electronically with the help of a corresponding control signal. For example, the switchable connection can be switched on and off in every situation of the wind turbine, for example, independently of the electrostatic charge which has accumulated in the electrical system.

When the at least one switchable connection is in the closed state, that is, when the at least one switchable connection is switched on, the electrical system is connected to ground, so that the accumulated electrostatic charge in the electrical system can be dissipated to ground. When the at least one switchable connection is switched off, that is, in the open state, the electrical system is not grounded. That is, electrostatic charge in the electrical system, which does not result in a voltage difference to ground as high as the breakdown voltage, cannot be dissipated to ground. The accumulated electrostatic charge is measured in the power box, disposed, for example, between a heating cable and the ground. The measurement is carried out via DC voltage measurement and threshold value signaling over a time average.

The wind turbine may include several switchable connections which can be controllably switched in order to establish an electrical connection between the electrical system and ground. All features disclosed herein with respect to one switchable connection are also disclosed for all other switchable connections.

According to a further embodiment, the electrical system includes a blade heating system for preventing accumulation of ice on the rotor blade. For example, when the blade heating system is operated, it heats up the outer surface of the rotor blade, so that ice cannot be formed on the rotor blade or so that already accumulated ice melts.

According to a further embodiment, the electrical system includes a first main conductor. The first main conductor is assigned to the suction side of the rotor blade. For example, the first main conductor is securely disposed on or embedded in the suction side. The suction side may be formed by an upper half shell of the rotor blade.

According to a further embodiment, the electrical system includes a second main conductor. The second main conductor is assigned to the pressure side of the rotor blade. For example, the second main conductor is securely disposed on or embedded in the pressure side. The pressure side may be formed by a lower half shell of the rotor blade.

According to a further embodiment, the at least one switchable connection is electrically coupled to the first main conductor and a ground terminal. Alternatively, the at least one switchable connection may be electrically coupled to the second main conductor and the ground terminal. In a further alternative, there are two or more switchable connections and at least one switchable connection is electrically coupled to the first main conductor and the ground terminal and at least one further switchable connection is electrically coupled to the second main conductor and the ground terminal.

According to a further embodiment, the blade heating system is supplied with power via the first main conductor and the second main conductor during operation. A further switch may be used to enable or disable power transfer to the heating system via the first and the second main conductors.

By way of example, the blade heating system includes at least one electro-thermal heating element. The electro-thermal heating element includes, for example, a heating wire. When electric current is flowing through the electro-thermal heating element, the electro-thermal heating element heats up, which results in heating of the rotor blade. The electro-thermal heating element may be embedded in or located underneath the rotor blade shell(s). The electro-thermal heating element may be arranged to transfer the electric current between the first and the second main conductor. For example, when the above-mentioned further switch is closed, electric current flows between the first and the second main conductor via the at least one electro-thermal heating element. When the further switch is open, no current is flowing through the at least one electro-thermal heating element. The heating system may be a thermal resistance heating system.

According to a further embodiment, the wind turbine further includes at least one needle electrode extending from a trailing edge of the rotor blade. A plurality of needle electrodes may extend from the trailing edge of the rotor blade. The needle electrodes may be spaced from each other in longitudinal direction which is a direction parallel to the length axis of the rotor blade.

The needle electrode(s) can further help to prevent or reduce electrostatic charge in the electrical system of the rotor blade and/or electrostatic charge accumulated on the surface of the rotor blade. At least one needle electrode may be electrically connected to the first main conductor and/or to the second main conductor and/or to the lightning protection system. Due to the needle-shape with a sharp edge of the end, an electric field will develop and cause corona discharge which will transfer electrostatic charge to the air. In this way, the electrostatic charge is limited.

Next, the method for operating a wind turbine is specified. The method is, in particular, suitable for operating the wind turbine according to any of the embodiments described herein. Therefore, all features disclosed for the wind turbine are also disclosed for the method and vice versa.

According to an embodiment, the method includes a step of determining first information which is representative of whether the electrical system is to be operated or to be stopped if already in operation. If the first information is representative of the fact that the electrical system is to be operated, a first control signal is generated for the at least one switchable connection. The first control signal is configured to switch the at least one switchable connection into the open state. If, on the other hand, the first information is representative of the fact that operation of the electrical system is to be stopped, a second control signal is generated for the at least one switchable connection. The second control signal is configured to switch the least one switchable connection into the closed state.

This method is particularly useful when the electrical system of the wind turbine cannot be operated when grounded. The ground connection is therefore only established when the electrical system is stopped or is to be stopped, that is, operation is at least interrupted. During the interruption of operation of the electrical system, the accumulated electrostatic charge can be dissipated to ground via the at least one closed switchable connection. When the electrical system needs to return to operation, the at least one switchable connection can again be opened and the connection to ground is removed. For example, the switchable connection is closed as long as the operation of the electrical system is stopped or paused, respectively. The switchable connection may be opened as long as the electrical system is operated.

The method specified herein is, in particular, a computer-implemented method, that is, is performed with the help of a computer or a processor.

The control signals are configured to switch the switchable connection between open state and closed state. This means that the control signals, when received by a suitable control unit, cause the control unit to switch the switchable connection. The control unit may be an actuator, for example.

According to a further embodiment, the first control signal and the second control signal are generated repeatedly and alternatingly.

According to a further embodiment, for example during icing conditions, a time interval from generating the first control signal to generating the second control signal is longer than a time interval from generating the second control signal to generating the next first control signal. Particularly, the time interval in which the electrical system is operated is longer than the time interval in which the operation of the electrical system is stopped or paused, respectively. However, in another embodiment, for example in the absence of icing conditions, the time interval from generating the first control signal to generating second control signal may vary as per requirement.

According to a further embodiment, the lengths of the time intervals are predetermined. Accordingly, the operation of the electrical system is stopped/paused in a planned manner in order to enable discharging of the electrical system.

According to a further embodiment, the method further includes the step of providing second information, which is representative of electrostatic charge in the rotor blade, particularly in the electrical system thereof. The first information is then determined depending on the second information. For example, if a first criterion is fulfilled, which includes that the second information, representative of the electrostatic charge formation, exceeds a predetermined threshold value, the first information is determined such that it is representative of that the electrical system is to be stopped. For example, if a second criterion is fulfilled, which includes that the second information, representative of the electrostatic charge formation, is below or equal to the predetermined threshold, the first information is determined such that it is representative of that the electrical system is to be started or continued.

In other words, if the condition is fulfilled that the second information is representative of an amount of electrostatic charge which exceeds a predetermined threshold value, and, optionally, if one or more further conditions are fulfilled, the first information is determined such that it is representative of the fact that the operation of the electrical system is to be stopped. The predetermined threshold value is, in particular, smaller than the breakdown voltage. If, on the other hand, the second information is representative of an amount of electrostatic charge equal or below the predetermined threshold value, and, optionally, if one or more further conditions are fulfilled, the first information is determined to start/continue operation of the electrical system.

The second information may be determined by detecting the electrostatic charge with the help of a DC-offset in the phase to ground voltage. The first information depends on second information and optionally, also on wind turbine information including, but not limited to, generated power, ambient temperature, frequency of oscillation, and icing sensor signals et cetera.

Next, the computer program, the computer-readable data carrier and the control device are specified.

According to an embodiment, the computer program includes instructions which, when the program is executed by a control device, cause the control device to carry out the method for operating a wind turbine according to any one of the embodiments described herein.

According to an embodiment, the computer-readable data carrier has the computer program stored thereon.

According to an embodiment, the control device includes means configured to execute the method for operating a wind turbine according to any one of the embodiments described herein. Particularly, the method is carried out when the above-mentioned computer program is executed by the control device. All features disclosed for the method are therefore also disclosed for the control device and vice versa.

The control device includes, for example, at least one processor and/or at least one programmable logic controller, plc for short. The control device may be part of the wind turbine specified herein.

According to an embodiment, the control device is signally connected or signally connectable to a control unit for the at least one switchable connection in order to switch the at least one switchable connection according to the first and second control signals. For example, when the control unit receives the control signals, the switchable connection is switched accordingly.

### BRIEF DESCRIPTION OF DRAWINGS

The invention will now be described with reference to the drawings wherein:

FIG. 1 shows an embodiment of a wind turbine;

FIG. 2 shows an embodiment of a rotor blade;

FIG. 3 shows a flowchart of an embodiment of the method for operating a wind turbine; and,

FIG. 4 shows a schematic view of an embodiment of a system including a rotor blade and a control device.

### DETAILED DESCRIPTION

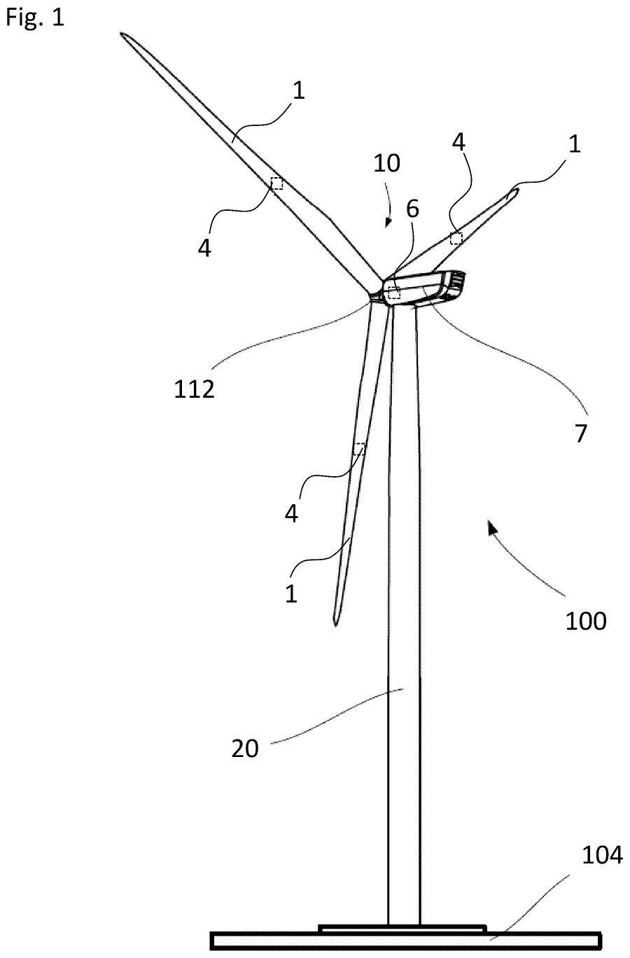

FIG. 1 shows a schematic view of an embodiment of a wind turbine 100 which includes a tower 20. The tower 20 is fixed to the ground via a foundation 104. At one end of the tower 20, opposite to the ground, a nacelle 7 is rotatably mounted. The nacelle 7 includes a generator (not shown) which is coupled to a rotor 10 via a gearbox (not shown). The rotor 10 includes three (wind turbine) rotor blades 1 which are arranged on a rotor hub 112, the rotor hub 112 being connected to a rotor shaft (not shown).

During operation, the rotor 10 is set in rotation by an air flow, for example wind. This rotational movement is transmitted to the generator via the rotor shaft and the gearbox. The generator converts the mechanical energy of the rotor 10 into electrical energy.

Each rotor blade 1 is equipped with an electrical system 4. Such an electrical system 4 may include a blade heating system. Indeed, when the wind turbine 100 is located in a cold region, it may happen that ice accumulates on the rotor blades 1. The blade heating system helps to prevent the accumulation of ice or helps to get rid of the ice. A blade heating system is only one example. Other electrical systems may be used as well. For example, the electrical system 4 may include a light system and/or an acoustic system in order to emit light and/or acoustic signals. This may prevent collision with flying objects, for example. The electrical system 4 of each rotor blade 1 may further include a lightning protection system in order to dissipate lightning currents caused by lightnings.

The operation of the electrical systems 4 of the rotor blades 1 is controlled by a control device 6 which, in this example, is located in the nacelle 7. It could also be located in the rotor hub 112, for example.

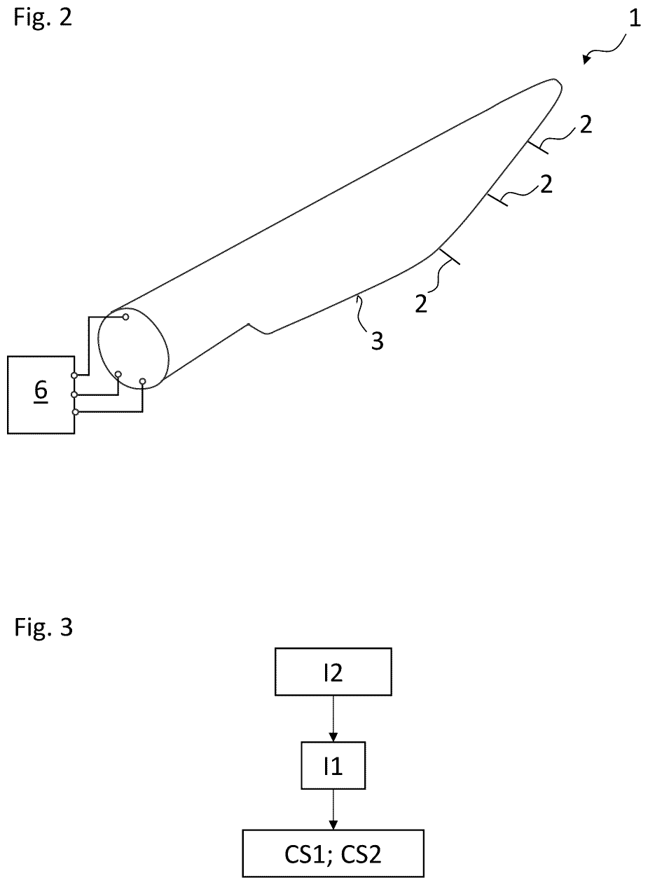

FIG. 2 shows an embodiment of a single rotor blade 1 signally connected to the control device 6. The rotor blade 1 includes a trailing edge 3 from which a plurality of needle electrodes 2 extend. The needle electrodes 2 enable discharging of electrostatic charge which has accumulated in the electrical system of the rotor blade 1. Due to the sharp edge of the needle electrodes 2, high electric fields can develop there and cause corona discharge which helps to transfer the electrostatic charge to the surrounding air.

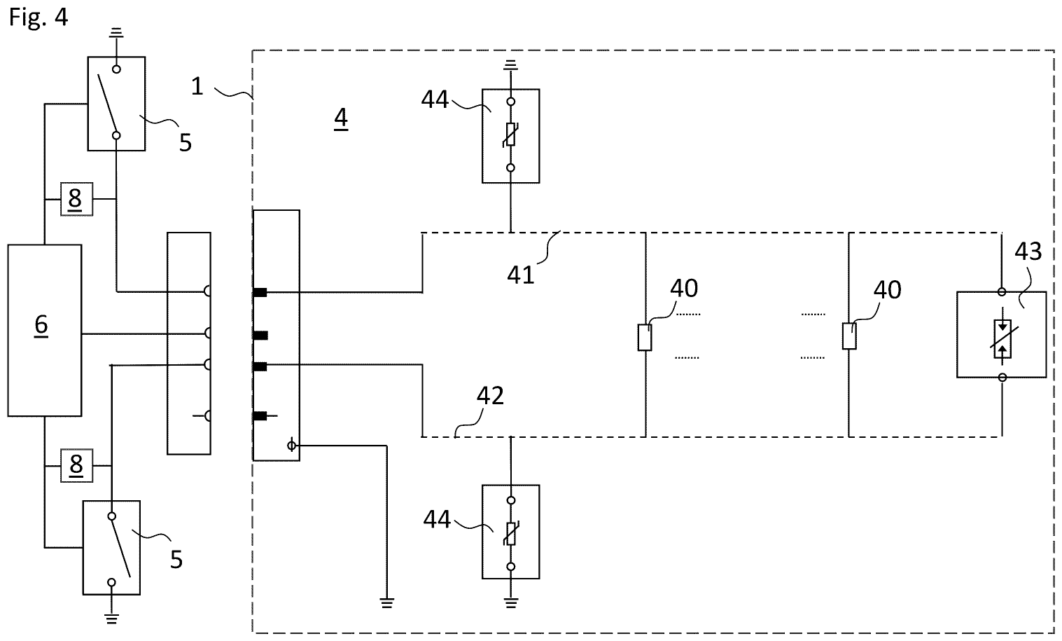

Additionally to the needle electrodes 2, the rotor blade 1 is equipped with further means for dissipating electrostatic charge. Such means are indicated in FIG. 4.

FIG. 4 is a schematic view of a system with the rotor blade 1 and the control device 6 signally connected to each other. This system may be used in the embodiment of FIG. 1, for example.

The rotor blade 1 includes the electrical system 4 mentioned above. The electrical system 4 is electrically connected to the control device 6 and to power boxes 8 via a rotary electrical interface which enables power and/or electrical signal and/or optical signal transfer between the control device 6 and power boxes 8 and the electrical system 4. The rotary electrical interface may be a slip ring unit or a galvanic rotational transfer system.

The electrical system 4 includes a first main conductor 41 and a second main conductor 42. The first main conductor 41 is, for example, securely disposed on the suction side of the rotor blade 1 and the second main conductor 42 is, for example, securely disposed on the pressure side of the rotor blade 1.

The first main conductor 41 and the second main conductor 42 are electrically connected or connectable to each other via electro-thermal heating elements 40, which are part of the blade heating system. The connection of first main conductor 41 or the second main conductor 42 to the ground can be switchably controlled with the help of the control device 6 to dissipate electrostatic charge or to connect to a power supply by disconnecting the first main conductor 41 and second main conductor 42 from the ground to operate the heating system.

The first main conductor 41 and the second main conductor 42 are both connected to protection devices 44. The protection devices 44 automatically connect the main conductors 41, 42 to ground when a breakdown voltage between the main conductors 41, 42 and ground is reached during lightning condition. The main conductors 41, 42 together with the associated protection devices 44 and a surge protection device 43 as shown in FIG. 4 are part of the lightning protection system of the rotor blade 1. The surge protection device 43 is open until a lightning strikes the rotor blade.

In order to enable the dissipation of electrostatic charge in the rotor blade 1 to ground before the breakdown voltage is reached, two switchable connections 5 which can be controllably switched are provided. These switchable connections 5 can be switched intentionally if discharging of the rotor blade 1 is desired. The switchable connections 5 can be controlled via the control device 6. When the switchable connections 5 are open, the main conductors 41, 42 are not connected to ground. When the switchable connections 5 are closed, the main conductors 41, 42 are connected to ground terminals and electrostatic charge can be dissipated.

FIG. 3 shows an embodiment of the method for operating a wind turbine based on a flow chart. The wind turbine is, for example, the wind turbine of FIG. 1 and includes the system of FIG. 4.

The method includes a step in which second information I2 is provided. The second information I2 is representative of electrostatic charge formation in the rotor blade 1. For example, the second information I2 is representative of the amount of electrostatic charge in the first and/or the second main conductor of the rotor blade 1.

If a first criterion is fulfilled, which includes that the second information I2 exceeds a predetermined threshold value, that is, the amount of electrostatic charge in the rotor blade exceeds a predetermined threshold value, first information I1 is generated such that the first information I1 is representative of the fact that operation of the electrical system 4 is to be stopped. On the other hand, if a second criterion is fulfilled which includes that the second information I2 does not exceed the predetermined threshold value, that is, the amount of electrostatic charge in the rotor blade does not exceed the predetermined threshold value, the first information I1 is determined such that it is representative of the fact that the electrical system is to be operated.

Then, control signals CS1, CS2 are determined depending on the first information I1. A first control signal CS1 is generated if the first information I1 is representative of the fact that the electrical system is to be operated and a second control signal CS2 is generated if the first information I1 is representative of the fact that the electrical system is not to be operated, for example, stopped or paused. The first control signal CS1 is for the at least one switchable connection 5 and is configured to switch the at least one switchable connection 5 into the open state. The second control signal CS2 is also for the at least one switchable connection 5 and is configured to switch the at least one switchable connection 5 into the closed state.

The method can, preferably, be a computer-implemented method, that is, is performed with the help of a computer or a processor. In particular, the method can be carried out by a controller, preferably the control device 6. Thus, the method of FIG. 3 may be performed by the control device 6. For this purpose, the control device 6 may include at least one processor. The control device 6 may further include a power box 8 for powering the electrical conductors 41, 42. Carrying out the method can be caused by a computer program that is executed by the control device 6 and that includes instructions which, when the program is executed by the control device 6, cause the control device 6 to carry out the method for operating the wind turbine. The computer program can be stored on a computer-readable data carrier. Thus, FIG. 3 also represents the computer program and the computer-readable data carrier.

It is understood that the foregoing description is that of the preferred embodiments of the invention and that various changes and modifications may be made thereto without departing from the spirit and scope of the invention as defined in the appended claims.

### REFERENCE SIGNS

1 rotor blade
2 needle electrode
3 trailing edge
4 electrical system
5 switchable connection
6 control device
7 nacelle
8 power box
10 rotor
20 tower
40 electro-thermal heating element
41 first main conductor
42 second main conductor
43 surge protection device
44 protection device
100 wind turbine
104 foundation
112 rotor hub
I1 first information
I2 second information
CS1 first control signal
CS2 second control signal

1. A wind turbine comprising:
a rotor blade;
an electrical system embedded in said rotor blade;
at least one switchable connection between said electrical system and ground; and,
said at least one switchable connection being controllably switchable between an open state and a closed state so that:
when said at least one switchable connection is in said closed state, the electrical system is grounded, and,
when said at least one switchable connection is in said open state, said electrical system is not grounded.

2. The wind turbine of claim 1, wherein said electrical system includes a blade heating system for preventing accumulation of ice on said rotor blade.

3. The wind turbine of claim 1, wherein:
said electrical system includes a first main conductor securely disposed on a suction side of said rotor blade and a second main conductor securely disposed on a pressure side of said rotor blade; and,
said at least one switchable connection is electrically coupled to at least one of:
said first main conductor and a ground terminal, and,
said second main conductor and said ground terminal.

4. The wind turbine of claim 3, wherein:
said electrical system includes a blade heating system for preventing accumulation of ice on said rotor blade; and,
during operation, said heating system is supplied with power via said first main conductor and said second main conductor.

5. The wind turbine of claim 1 further comprising at least one needle electrode extending from a trailing edge of said rotor blade.

6. A method for operating a wind turbine including a rotor blade, an electrical system embedded in the rotor blade, at least one switchable connection between the electrical system and ground, and, the at least one switchable connection being controllably switchable between an open state and a closed state so that when the at least one switchable connection is in the closed state, the electrical system is grounded, and, when the at least one switchable connection is in the open state, the electrical system is not grounded, the method comprising:
determining first information which is representative of whether the electrical system is to be operated or is to be stopped if already in operation;
generating a first control signal for the at least one switchable connection, which is configured to switch the at least one switchable connection into the open state if the first information is representative that the electrical system is to be operated; and,
generating a second control signal for the at least one switchable connection, which is configured to switch the at least one switchable connection into the closed state if the first information is representative that operation of the electrical system is to be stopped.

7. The method of claim 6, wherein the first control signal and the second control signal are generated repeatedly and alternatingly.

8. The method of claim 7, wherein during icing conditions, a time interval from generating the first control signal to generating the second control signal is longer than a time interval from generating the second control signal to generating the next first control signal.

9. The method of claim 8, wherein lengths of the time intervals are predetermined.

10. The method of claim 6 further comprising:
providing second information which is representative of electrostatic charge formation in the rotor blade; and,
determining the first information depending on the second information.

11. A computer program comprising instructions which, when the program is executed by a control device, cause the control device to carry out the method of claim 6.

12. A non-transitory computer-readable data carrier having the computer program of claim 11 stored thereon.

13. A control device comprising means for executing the method of claim 6.

14. A wind turbine comprising:
a rotor blade;
an electrical system embedded in said rotor blade;
at least one switchable connection between said electrical system and ground; and,
said at least one switchable connection being controllably switchable between an open state and a closed state so that when said at least one switchable connection is in said closed state, the electrical system is grounded, and,
when said at least one switchable connection is in said open state, said electrical system is not grounded;
a control device including a processor and a non-transitory computer readable medium having program code stored thereon;
said program code being configured, when executed by said processor, to:
determine first information which is representative of whether said electrical system is to be operated or is to be stopped if already in operation;
generate a first control signal for said at least one switchable connection, which is configured to switch said at least one switchable connection into said open state if the first information is representative that said electrical system is to be operated; and,
generate a second control signal for said at least one switchable connection, which is configured to switch said at least one switchable connection into said closed state if the first information is representative that operation of said electrical system is to be stopped.
